(19) United States
(12) Patent Application Publication
(10) Pub. No.: US 2019/0359241 A1
(43) Pub. Date: Nov. 28, 2019

(54) Collapsible Personal Trolley

(71) Applicant: Eric G. Parker, Naples, FL (US)

(72) Inventor: Eric G. Parker, Naples, FL (US)

(21) Appl. No.: 16/439,951

(22) Filed: Jun. 13, 2019

Related U.S. Application Data
(63) Continuation-in-part of application No. 15/925,142, filed on Mar. 19, 2018, now Pat. No. 10,322,735.
(60) Provisional application No. 62/472,740, filed on Mar. 17, 2017.

(51) Int. Cl. B62B 1/12

(52) U.S. Cl. CPC B62B 1/12; B62B 1/14

(57) ABSTRACT

A collapsible trolley or other transport device includes a body having a back panel, a shelf panel pivotally attached to a bottom edge of the back panel, a pair of back wing panels pivotally attached one each to opposing side edges of the back panel, a pair of shelf wing panels pivotally attached one each to opposing side edges of the shelf panel and a pair of auxiliary panels pivotally attached one each to the pair of shelf wing panels and attached to bottom portions of the pair of back wing panels. The body is movable between an unfolded use configuration and a folded storage configuration. A pair of wheels is attached to the pair of back wing panels and the pair of auxiliary panels by a pair of wheel brackets.

### CLAIM OF PRIORITY

This application is a Continuation-in-Part of U.S. patent application Ser. No. 15/925,142, filed Mar. 19, 2018, currently pending, which claims the benefit of U.S. Provisional Application No. 62/472,740, filed Mar. 17, 2017, the contents of both of which are hereby incorporated by reference.

### FIELD OF THE INVENTION

The present invention relates generally to carts for groceries and other retail items and, more particularly, to a collapsible personal trolley.

### BACKGROUND

Shoppers in retail stores typically use shopping carts or baskets owned by the store to hold their purchases as they travel through the More. Purchases are typically bagged at the check out counter and either reloaded into the cart or the bags themselves are carried out of the store by the shopper. Carrying the bags is cumbersome for the shopper and the number of bags that a shopper can carry is limited by the strength of his or her arms. With regard to using shopping carts outside of the store, such an arrangement does not work for city shoppers who walk to and from the store. In addition, even if the shopper drives to the store, and carries the groceries to his or her car with a store-owned cart, the store must go to the trouble of collecting the carts from the parking lot. In addition, the carts must be maintained, repaired and stored, which can add up to significant costs and take up valuable storage space.

Consumer-owned folding wire carts for use in shopping are known. The shopper brings the cart to the store, opens/unfolds it, and uses it to hold items during shopping. The shopper then uses the same cart after checkout to transport the purchases to his or her car or home. The disadvantage of such carts, however, is that they can be heavy due to the metal wire construction. In addition, they tend to feature a very utilitarian appearance. They also typically do not fold completely flat, and thus take up valuable space which is undesirable (especially when the shopper is an apartment dweller).

In view of the above, a need exists for a collapsible personal trolley that is inexpensive, lightweight, durable and attractive.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a collapsible trolley features a body including: a back panel; a shelf panel pivotally attached to a bottom edge of the back panel; a pair of back wing panels pivotally attached one each to opposing side edges of the back panel; a pair of shelf wing panels pivotally attached one each to opposing side edges of the shelf panel and a pair of auxiliary panels pivotally attached one each to the pair of shelf wing panels and attached one each to bottom edges of the pair of shelf wing panels. The body is movable between an unfolded use configuration, where the pair of back wing panels, pair of shelf wing panels and the shelf panel are all generally at an angle of approximately 90⁰ with respect to the back panel so that the pair of back wing panels and the pair of shelf wing panels cooperate to support the shelf panel, and a folded storage configuration where the pair of back wing panels are generally in the same plane as the back panel, the pair of shelf wing panels are generally in the same plane as the shelf panel, the shelf panel overlays a portion of the back panel and the shelf wing panels overlay portions of the back wing panels. The trolley also features a first wheel and a first wheel bracket having a first top end portion, a first bottom end portion and a first abutment portion. A first one of the pair of back wing panels has a first bracket top slot and a first bracket bottom outer opening. A first one of the pair of auxiliary panels has a first bracket bottom inner opening aligned with the first bracket bottom outer opening. The first wheel bracket top end portion is secured through the first bracket top slot and the first wheel bracket bottom end portion is secured through the first bracket bottom outer and inner openings so that the first wheel is rotatably positioned between the first back wing panel and the first abutment portion of the first wheel bracket and the first wheel bracket top end portion is covered by the first one of the pair of auxiliary panels. The trolley also features a second wheel and a second wheel bracket having a top end portion, a second bottom end portion and a second abutment portion. A second one of the pair of back wing panels has a second bracket top slot and a second bracket bottom outer opening. A second one of the pair of auxiliary panels has a second bracket bottom inner opening aligned with the second bracket bottom outer opening. The second wheel bracket top end portion is secured through the second bracket top slot and the second wheel bracket bottom end portion is secured through the second bracket bottom outer and inner openings so that the second wheel is rotatably positioned between the second back wing panel and the second abutment portion of the second wheel bracket and the second wheel bracket top end portion is covered by the second one of the pair of auxiliary panels.

In another aspect, a collapsible trolley features a body including: a back panel; a shelf panel pivotally attached to a bottom edge of the back panel; a pair of back wing panels pivotally attached one each to opposing side edges of the back panel; a pair of shelf wing panels pivotally attached one each to opposing side edges of the shelf panel and a pair of auxiliary panels pivotally attached one each to the pair of shelf wing panels and attached one each to bottom edges of the pair of shelf wing panels. The body is movable between an unfolded use configuration, where the pair of back wing panels, pair of shelf wing panels and the shelf panel are all generally at an angle of approximately 90° with respect to the back panel so that the pair of back wing panels and the pair of shelf wing panels cooperate to support the shelf panel, and a folded storage configuration where the pair of back wing panels are generally in the same plane as the back panel, the pair of shelf wing panels are generally in the same plane as the shelf panel, the shelf panel overlays a portion of the back panel and the shelf wing panels overlay portions of the back wing panels. The trolley also features a first wheel and a first wheel bracket having a first top end portion, a first bottom end portion and a first abutment portion. A first one of the pair of back wing panels has a first bracket top slot and a first bracket bottom outer opening. A first one of the pair of auxiliary panels has a first bracket bottom inner opening aligned with the first bracket bottom outer opening. The first wheel bracket top end portion is secured through the first bracket top slot and the first wheel bracket bottom end portion is secured through the first bracket bottom outer and inner openings so that the first wheel is rotatably trapped between the first back wing panel and the first abutment portion of the first wheel bracket and a cargo space over the shelf panel is shielded from the first wheel bracket top end portion by the first one of the pair of auxiliary panels. The trolley also features a second wheel and a second wheel bracket having a top end portion, a second bottom end portion and a second abutment portion. A second one of the pair of back wing panels has a second bracket top slot and a second bracket bottom outer opening. A second one of the pair of auxiliary panels has a second bracket bottom inner opening aligned with the second bracket bottom outer opening. The second wheel bracket top end portion is secured through the second bracket top slot and the second wheel bracket bottom end portion is secured through the second bracket bottom outer and inner openings so that the second wheel is rotatably trapped between the second back wing panel and the second abutment portion of the second wheel bracket and a cargo space over the shelf panel is shielded from the second wheel bracket top end portion by the second one of the pair of auxiliary panels.

In still another aspect, a folding transport device features a body including a pair of wing panels and a pair of auxiliary panels, said body movable between an unfolded use configuration and a folded storage configuration. The transport device also includes a first wheel and a first wheel bracket having a first top end portion, a first bottom end portion and a first abutment portion. A first one of the pair of wing panels has a first bracket top slot and a first bracket bottom outer opening and a first one of the pair of auxiliary panels having a first bracket bottom inner opening aligned with the first bracket bottom outer opening. The first wheel bracket top end portion is secured through the first bracket top slot and the first wheel bracket bottom end portion is secured through the first bracket bottom outer and inner openings so that the first wheel is rotatably positioned between the first wing panel and the first abutment portion of the first wheel bracket and the first wheel bracket top end portion is covered by the first one of the pair of auxiliary panels. The transport device also includes a second wheel and a second wheel bracket having a top end portion, a second bottom end portion and a second abutment portion. A second one of the pair of wing panels has a second bracket top slot and a second bracket bottom outer opening and a second one of the pair of auxiliary panels has a second bracket bottom inner opening aligned with the second bracket bottom outer opening. The second wheel bracket top end portion is secured through the second bracket top slot and the second wheel bracket bottom end portion is secured through the second bracket bottom outer and inner openings so that the second wheel is rotatably positioned between the second wing panel and the second abutment portion of the second wheel bracket and the second wheel bracket top end portion is covered by the second one of the pair of auxiliary panels.

### BRIEF DESCRIPTION OF THE DRAWINGS

FIG. 1 is a front perspective view of an embodiment of the collapsible personal trolley of the present disclosure in an unfolded use configuration;

FIG. 2 is a rear perspective view of the trolley of FIG. 1;

FIG. 3 is an enlarged partial front perspective view of the collapsible personal trolley of FIGS. 1 and 2 in the process of being placed in a folded storage configuration;

FIG. 4 is a front perspective view of the collapsible personal trolley of FIGS. 1 and 2 in a folded storage configuration;

FIG. 5 is a rear perspective view of the trolley of FIG. 4;

FIG. 6 is a front elevational view of a blank of material used to make the body of a second embodiment of the trolley;

FIG. 7 is an enlarged perspective view of the wheel attachment arrangement of the trolley of FIGS. 1-5;

FIG. 8 is an enlarged partial view of a wheel and back wing panel of the trolley of FIGS. 1-5;

FIG. 9 is a top perspective view of the trolley of FIGS. 1 and 2;

FIG. 10 is an enlarged perspective view of the clothing hook of FIG. 9;

FIG. 11 is an enlarged rear perspective view of the back panel of the trolley of FIGS. 1 and 2;

FIG. 12 is an enlarged partial perspective view illustrating use of the hitchhiker hooks of the trolley of FIGS. 1 and 2;

FIG. 13 is a perspective view of an alternative embodiment of the trolley of the disclosure in an unfolded used configuration;

FIG. 14 is a perspective view of the trolley of FIG. 13 in a partially folded configuration;

FIG. 15 is an enlarged perspective view of an embodiment of one of the wheel brackets of the trolley of the disclosure;

FIG. 16 is a is a front elevational view of a blank of material used to make the body of a third embodiment of the collapsible personal trolley of the present disclosure;

FIG. 17 is an enlarged perspective view of the wheel attachment arrangement of the collapsible personal trolley of FIGS. 16 and 18;

FIG. 18 is a front perspective view of the third embodiment of the collapsible personal trolley of the present disclosure in an unfolded use configuration;

FIG. 19 is a perspective view of the third embodiment of the trolley in a folded configuration for carrying, transport and/or storage;

FIG. 20 is a perspective view of the third embodiment of the trolley as it is being placed in the folded configuration of FIG. 19.

### DETAILED DESCRIPTION OF EMBODIMENTS

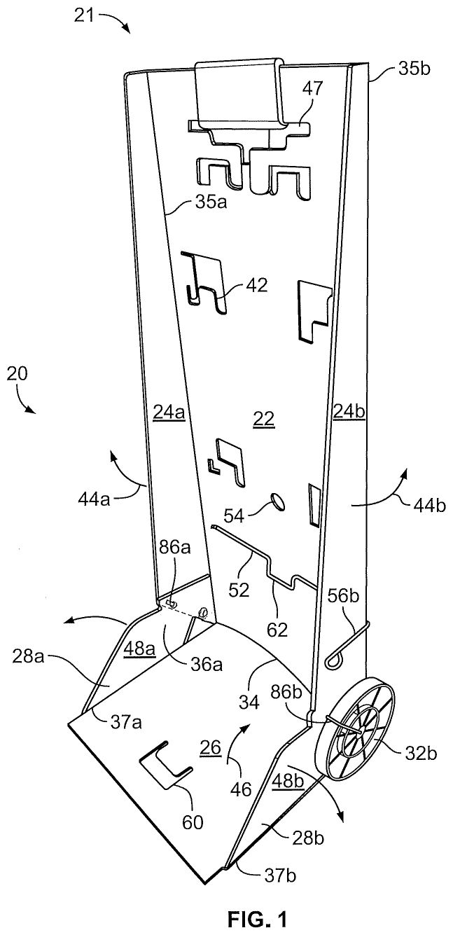

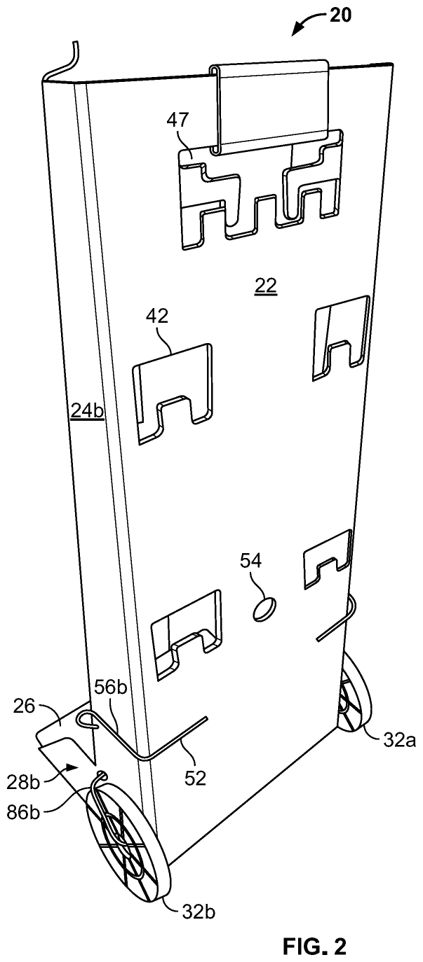

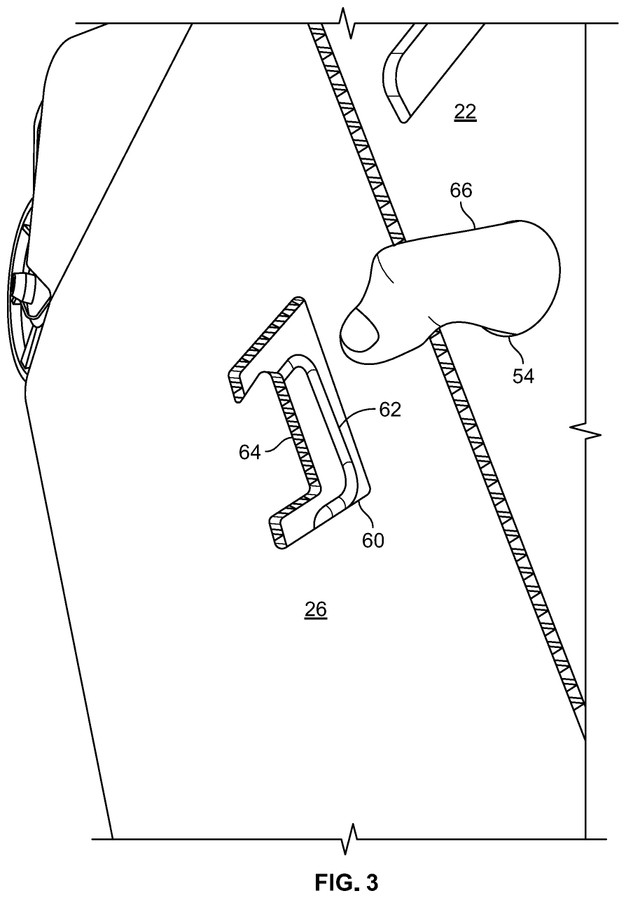

A first embodiment of the collapsible personal trolley of the disclosure is indicated in general at 20 in FIGS. 1, 2, 6 and 7. As illustrated in FIGS. 1, 4 and 8, the trolley includes a body, indicated in general at 21, that includes a back panel 22, back wings 24a and 24b, a shelf panel 26 and shelf wings 28a and 28b. Wheels (two) are mounted to the bottom rear portion of the back wings 24a and 24b. The left wheel is indicated at 32b in FIGS. 1-3, while the right wheel, not visible in FIGS. 1 and 2, is indicated at 32a in FIGS. 3. In alternative embodiments, the wheels may be mounted to the shelf wings 28a and 28b, the shelf panel 26 or the back panel 22.

The body 21 is preferably constructed from a single piece of corrugated plastic material, but any substantially rigid lightweight sheet material (that is preferably foldable) may be used including, but not limited to, corrugated cardboard, fiberglass, corrugated and non-corrugated composite materials and non-corrugated plastic. Advertising and/or attractive designs may be printed on the sheet of body material.

As illustrated in FIG. 1, a primary hinge 34 is formed at the junction of the bottom edge of the back panel 22 and the rear edge of the shelf panel 26. In addition wing-to-wing hinge 36a is formed between back wing 24a and shelf wing 28a while wing-to-wing hinge 36b is formed between back wing 24b and shelf wing 28b. Back wing hinges 35a and 35b are formed between the back panel 22 and back wings 24a and 24b, respectively. Shelf wing hinges 37a and 37b are formed between shelf panel 26 and shelf wings 28a and 28b, respectively. The hinges 34, 35a, 35b, 37a and 37b are preferably living hinges formed by a reduction in material thickness and/or folds in the cart body material, while the back wings and shelf wings are joined by wing-to-wing hinges 36a and 36b.

The trolley is shown in an unfolded use configuration in FIGS. 1 and 2. When in this configuration, a shopper may positioned bags and the like on shelf panel 26. In addition, the back panel 22 may be provided with bag-retaining cutouts, such as the ones indicated at 42 in FIGS. 1 and 2. With reference to FIG. 3, each cutout is provided with a generally rigid tab 43 from which the handle of a bag may be hung on the back panel 22. Further details regarding this feature, and other details regarding construction of the trolley, are provided in commonly owned U.S. Pat. No. 9,566,991 to Parker, the contents of which are hereby incorporated by reference.

The shopper may transport the loaded trolley by a user grasping the top handle cutout 47 and tilting the top portion backwards at an angle so that it may be rolled along the floor or ground on wheels 32a and 32b.

With reference to FIG. 1, when the user has completed his or her shopping trip, as described in the Parker '991 patent, the bags are removed from the trolley and back wing panels 24a and 24b are pivoted outwards, as indicated by arrows 44a and 44b, about hinges 35a and 35b, respectively. Shelf panel 26 is simultaneously pivoted toward back panel 22, about hinge 34, as illustrated by arrow 46. As this occurs shelf wings 28a and 28b pivot in the directions of arrows 48a and 48b about hinges 37a and 37b, respectively.

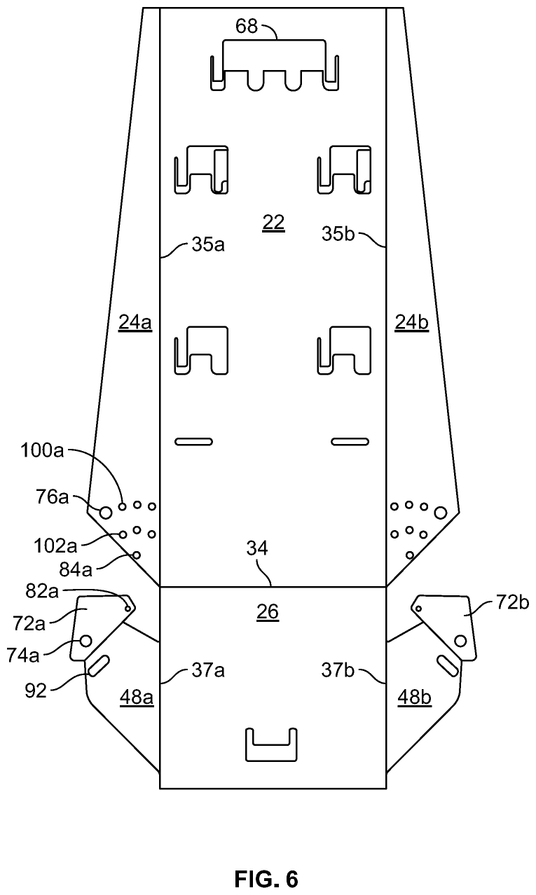

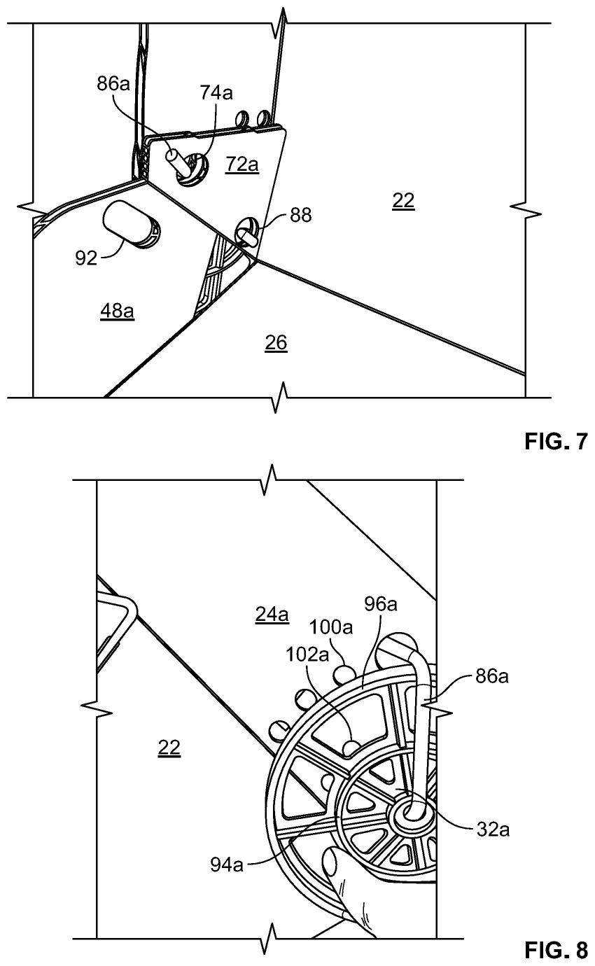

FIGS. 6 and 7 show the trolley in a folded storage position so as to be generally flat for ease of storage and transport. As described in the Parker '991 patent, in this position, shelf panel 26 is parallel to and overlays back panel 22. Shelf wing 28a similarly is parallel to and overlays back wing 24a, while shelf wing 28b is parallel to and overlays back wing 24b. Wheels 32a and 32b lie in a plane that is parallel to the plane of the back panel 22 of the trolley.

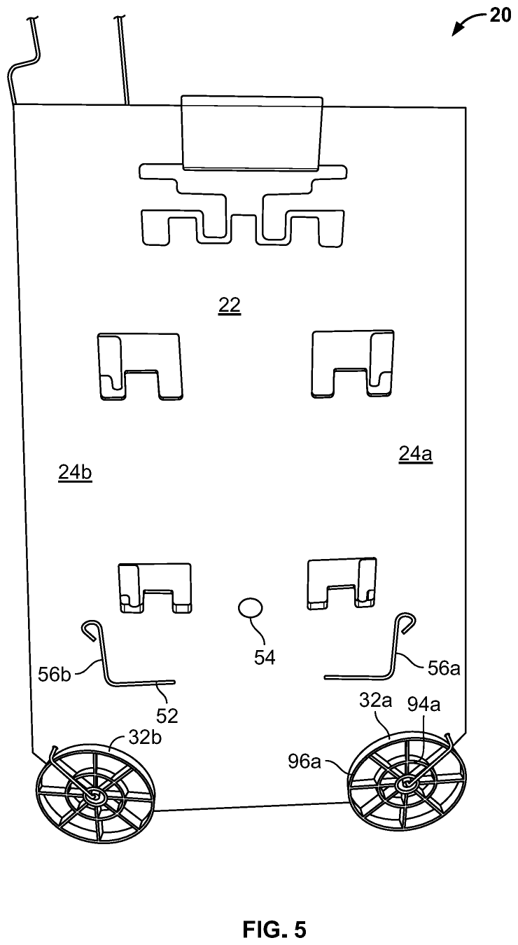

The trolley features a pivoting brace 52 (FIGS. 1, 2 and 5) that is pivotally attached to the back panel 22 of the trolley body. More specifically, as illustrated in FIG. 5, the pivoting brace is generally U-shaped and has a pivoting axle portion with arms 56a and 56b on opposite ends. The pivoting axle portion is secured to the back of the back panel such as by passing through openings in the back panel 22.

When the trolley is in the unfolded use configuration, as illustrated in FIGS. 1 and 2, the arms 56a and 56b of the pivoting brace 52 support back wings 24a and 24b to restrict them from pivoting outwards.

As indicated in FIGS. 1, 3 and 4, the shelf panel 26 is provided with a window opening 60. In addition, the pivoting brace 52 is provided with a central offset portion 62 sized to pass through the window 60. As illustrated in FIGS. 1., 3 and 4, the window opening 60 is provided with a tab 64 that is sized to be engaged by the offset portion 62 of the latching member.

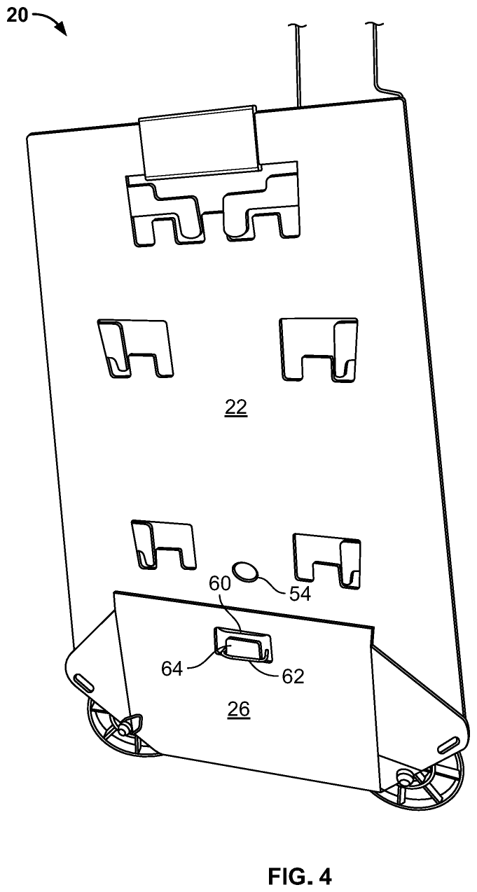

A thumb hole 54 (FIGS. 1-5) is provided in back panel 22 to aid in folding the trolley into the storage configuration (illustrated in FIGS. 4 and 5). More specifically, as illustrated in FIG. 3, a user places his or her thumb 66 through the back of the thumb opening 54. As a result, when the shelf panel 26 is folded into a position adjacent to the back panel 22, as illustrated in FIG. 3, the user may hold the shelf panel in this position using his or her thumb 66 as he or she pivots the pivoting brace 52 with his or her other hand. The latching member 52 may then be pivoted, via either lever portion 56a or 56b, into the position illustrated in FIG. 4 so that the offset portion 62 engages the tab 64 to latch the trolley in the generally flat, folded configuration for ease of storage or carrying.

When user desires to open the cart, he or she rotates the latching member 52 so that the offset portion 62 disengages from the tab 64. As a result, the trolley is free to unfold into the use configuration of FIGS. 1 and 2. Cargo may then be easily carried on the extended shelf panel 26.

An example of a blank used to form a body in a second embodiment of the collapsible trolley is shown in FIG. 6. Other than the configuration of the cutouts 68, the trolley body formed by the blank of FIG. 6 is identical to the trolley illustrated in FIGS. 1-5. The panels are folded about fold lines 35a, 35b, 34 and 37a, 37b to form the cart body 21 of FIGS. 1-5.

Panels 72a and 72b of FIG. 6 are joined to the bottom portions of wing panels 24a and 24b to form the body of the trolley (21 in FIG. 1). This is accomplished using the wheel brackets of the trolley. More specifically, with reference to panel 72a of FIG. 6, and after folding of the blank about lines 34, 35a and 37a of FIG. 6, wheel bracket top opening 74a is positioned in alignment with wheel bracket top opening 76a, while wheel bracket bottom opening 82a is positioned in alignment with wheel bracket bottom opening 84a. Panel 72b is similarly positioned.

Wheel brackets, indicated at 86a and 86b (FIGS. 1 and 2) secure the wheels 32a and 32b to the trolley body, as described in the Parker '991 patent. With reference to FIG. 7, the top end portion of the wheel bracket 86a passes through the aligned wheel bracket top openings 74a and 76a of FIG. 6 and is bent, while the bottom end portion of the wheel bracket 86a passes through the aligned wheel bracket bottom openings 82a and 84a of FIG. 6 and is provided with retainer 88. As a result, the bottom portion of wing panel 24a (FIG. 6) is secured to panel 72a. Wing panel 24b (FIG. 6) is secured to panel 72b in a similar fashion. As shown in FIGS. 6 and 7, shelf wing panel 48a is provided with elongated opening 92 which receives the bent top end of the wheel bracket when the trolley is in the folded configuration (FIGS. 4 and 5). Shelf wing panel 48b is similarly configured.

As shown in FIGS. 5 and 8, wheel 32a, which preferably is formed from molded plastic, includes concentric hub rim 94a and edge rim 96a, which preferably includes a rounded or tapered profile. Wheel 32b features a similar construction. Side loads are resisted by the hub and edge rims on the inner face of each wheel rubbing on the plane surface of the corresponding back wings 24a and 24b. With reference to FIGS. 6 and 8, back wing 24a is provided with an arcuate series of openings 102a and 100a which are traversed by the inner faces of the hub and edge rims 94a and 96a, respectively as the wheel 32a turns. This reduces wheel surface contact area with respect to the back wing 24a and thus minimizes the resistance to rolling. Wheel 32b and back wing panel 24b features a similar configuration.

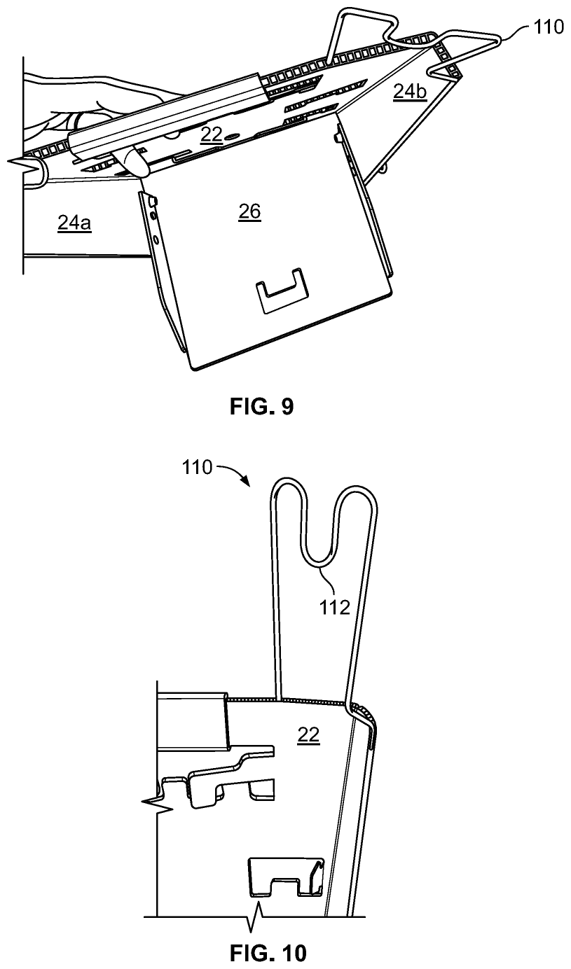

As illustrated in FIGS. 9 and 10, a wire clothes bracket 110 may be mounted to the top edge of the back panel 22 by removably inserting the bottom ends of the bracket into the corrugations of the panel. The bracket 110 may include any number of U-shape portions 112, or similar formations, such as a stair-step profile, to provide an engagement location for clothes hangers. As a result, clothing, such as dry cleaning or retail purchases, may be hung on the trolley so as to drape next to the back panel 22. As illustrated in FIGS. 9 and 10, the clothes bracket may extend between the back panel 22 and a back wing panel (such as 24b), when the trolley is in the unfolded use configuration, to increase structural rigidity of the bracket and trolley.

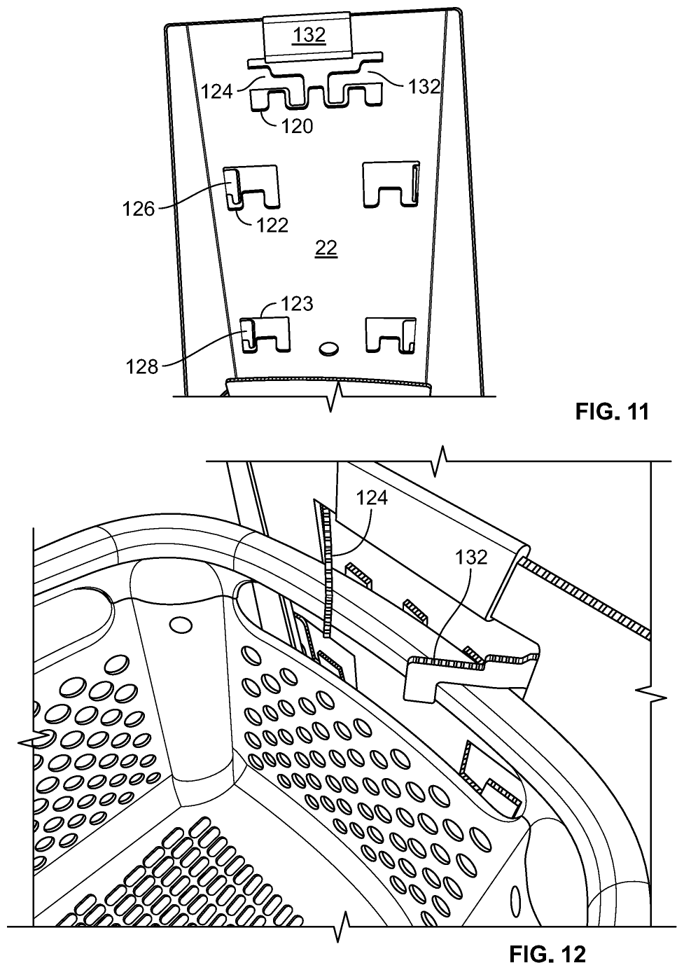

With reference to FIG. 11, back panel 22 cutouts 120, 122 and 123 are provided with hitchhiker tabs 124, 126 and 128, respectively. The hitchhiker tabs fold into positions that are generally perpendicular to the back panel 22 and form downward-facing hooks whereby the trolley may be suspended from a horizontal side wall wire or plastic wall of a traditional shopping cart. As a result, the collapsible trolley may be hung on the side or of the shopping cart, as illustrated in FIG. 12 while the user is shopping in a store,

With reference to FIG. 11, the top edge of cutout 120 forms a handle for carrying, pushing or pulling the trolley. As indicated at 132, a small sheet of corrugated material, or other foldable material, may be wrapped around the top edges of the cutout 120 and back panel 22 to strengthen the handle and make the handle more comfortable to grip.

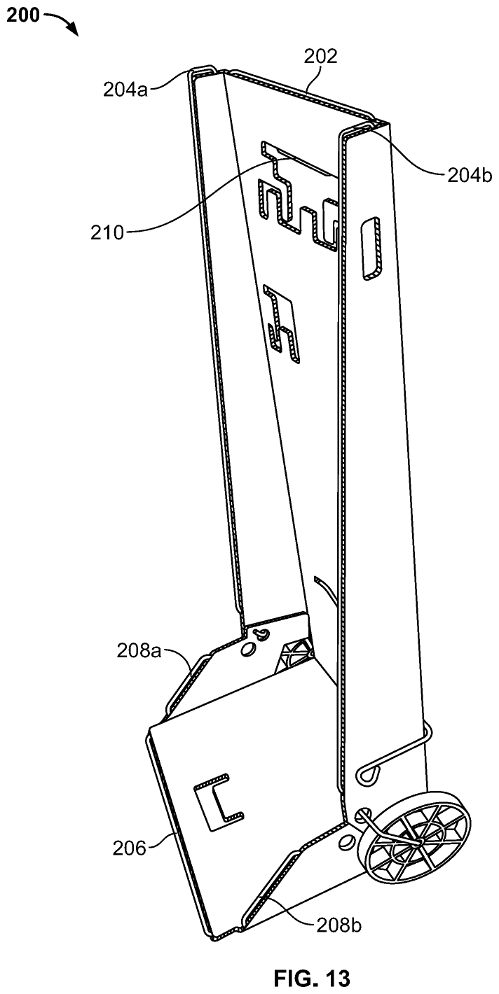

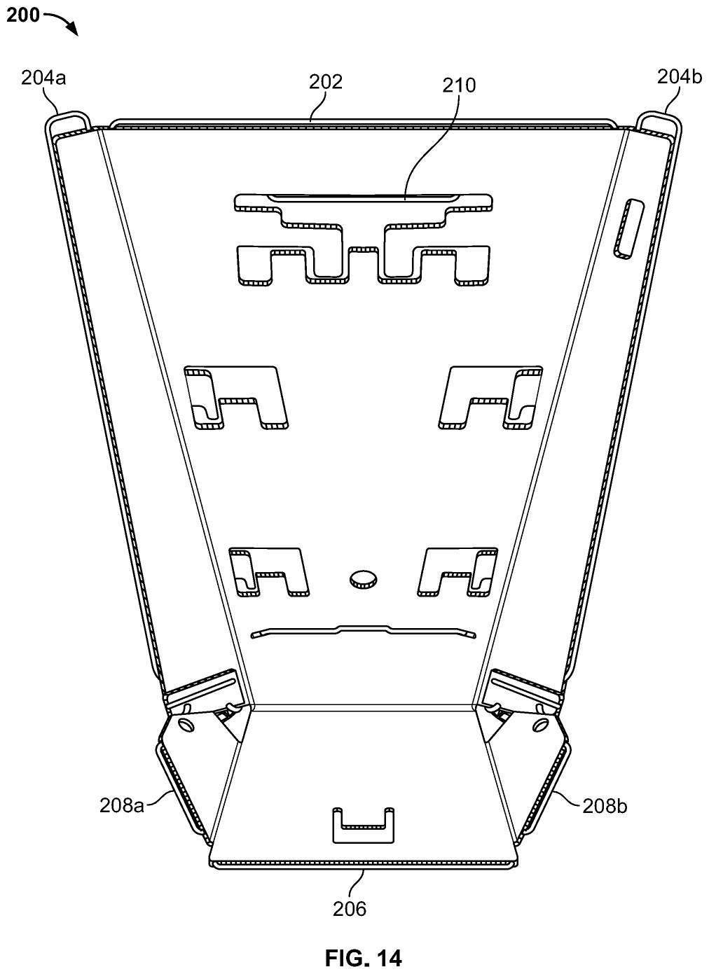

In an alternative embodiment of the collapsible personal trolley of the disclosure, indicated in general at 200 in FIGS. 13 and 14, the edges of the back panel, back wings, shelf panel and shelf wings are provided with wire sections 202, 204a and 204b, 206 and 208a and 208b, respectively, to improve the appearance of the trolley and to add structural support to the panels. In addition, the upper edge of the opening defining the handle opening in the back panel is provided with wire section 210 for strength and to provide the user with a more comfortable grip.

Each wire section 202, 204a and 204b, 206, 208a and 208b and 210 is provided with opposing end portions that form generally 90° angles with the primary intermediate portion. The end portions thus may be inserted into the corrugations of the corresponding panel to secure the wire section on the edge of the corresponding panel. The end portions may optionally be provided with adhesive prior to insertion into the panel corrugations. Alternative methods for securing the wire sections may be used including, but not limited to, fasteners or adhesive.

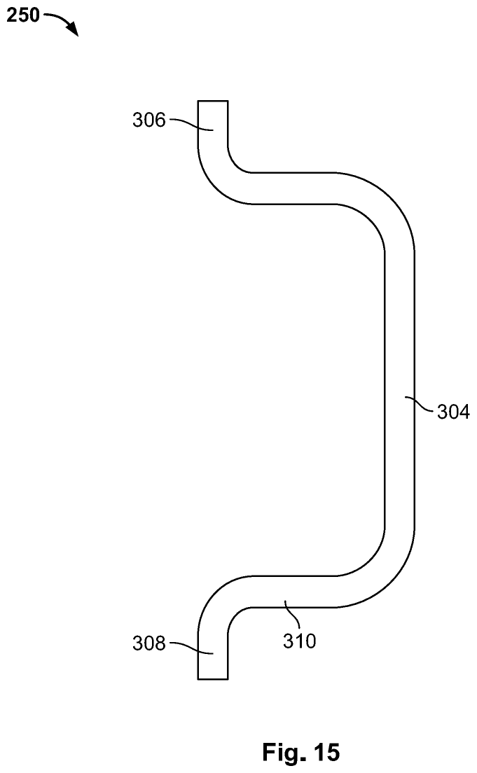

An embodiment of the wheel bracket of the disclosure is indicated in general at 250 in FIG. 15. As an example only, the wheel bracket may be constructed from steel wire, such as ¼ galvanized steel wire. The wheel bracket includes a wheel abutment portion 304, an upper end portion 306 and a lower end portion 308. The lower end portion 308 is joined to the abutment portion 304 by a wheel axle portion 310. As described above and below, the upper and lower end portions of the wheel bracket secure the bracket to the body of the trolley with a wheel trapped between the abutment portion and the body of the trolley. The wheel axle portion 310 passes through the center of the wheel and supports the wheel as it rotates while the trolley is in use. The bends forming the wheel bracket 250 occur in the same plane with the upper and lower end portions 306 and 308 offset the same distance from the abutment portion 304 (i.e. the length of wheel axle portion 310) so that the wheel bracket 250 may be used on either side of the trolley.

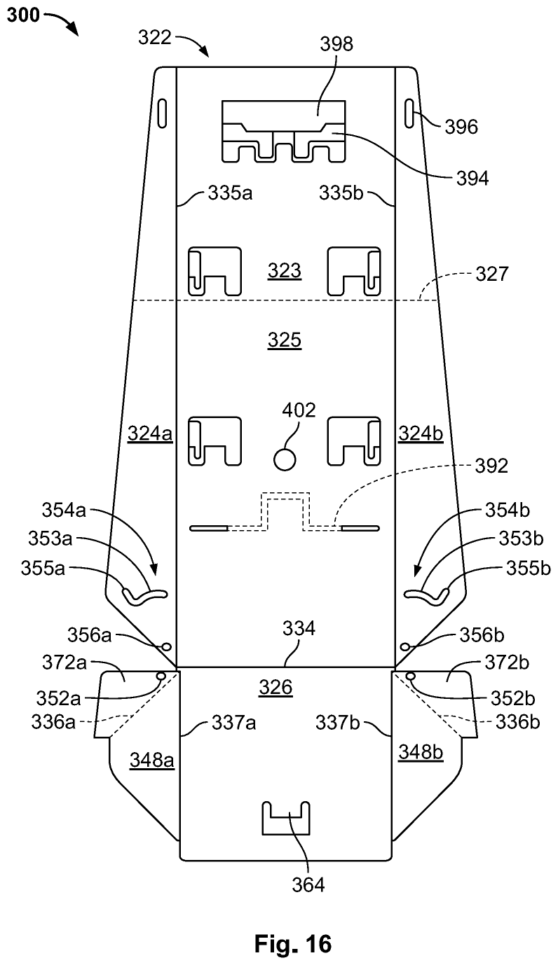

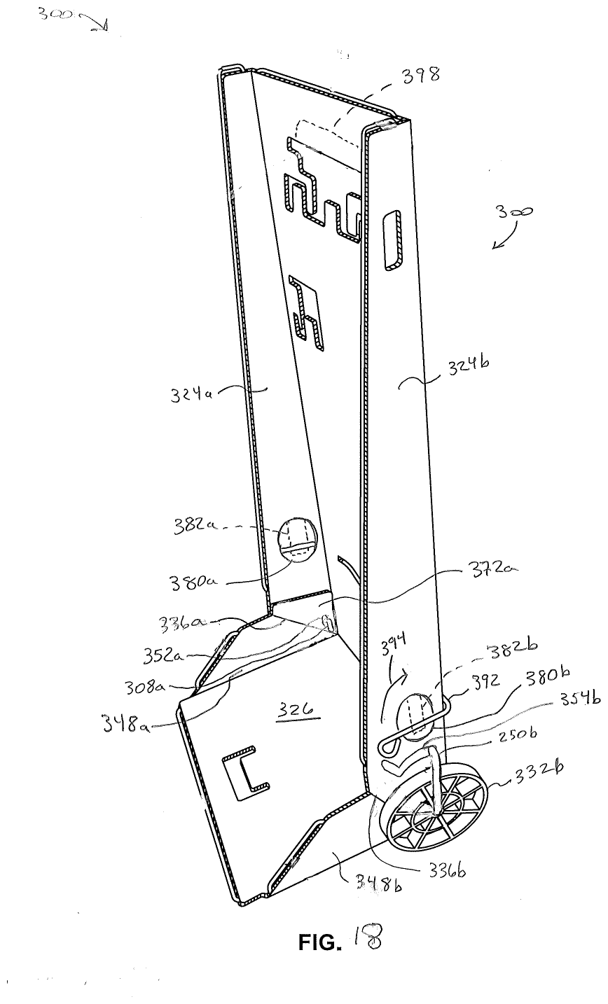

The body of a third embodiment of the collapsible personal trolley of the disclosure is indicated in general at 300 in FIGS. 16 and 18. As illustrated in FIG. 16, the body includes a back panel, indicated in general at 322, back wings 324a and 324b, a shelf panel 326 and shelf wings 348a and 348b. Back panel 322 includes a top portion 323 and a bottom portion 325 separated by hinge 327. Wheels (two) are mounted to the bottom rear portion of the back wings 324a and 324b. The left wheel is indicated at 332b in FIG. 18, while the right wheel is not visible,

The body 300 is preferably constructed from a single piece of corrugated plastic material, but any substantially rigid lightweight sheet material (that is preferably foldable) may be used including, but not limited to, corrugated cardboard, fiberglass, corrugated and non-corrugated composite materials and non-corrugated plastic. Advertising and/or attractive designs may be printed on the sheet of body material.

As illustrated in FIG. 16, a primary hinge 334 is formed at the junction of the bottom edge of the back panel 322 and the rear edge of the shelf panel 326. In addition, hinge 336a is formed between auxiliary panel 372a and shelf wing 348a while hinge 336b is formed between auxiliary panel 372b and shelf wing 348b. Back wing hinges 335a and 335b are formed between the back panel 322 and back wings 324a and 324b, respectively. Shelf wing hinges 337a and 337b are formed between shelf panel 326 and shelf wings 348a and 348b, respectively. The hinges 334, 335a, 335b, 337a and 337b are preferably living hinges formed by a reduction in material thickness and/or folds in the cart body material, while the back wings and shelf wings are joined by wing-to-wing hinges 336a and 336b.

The trolley is shown in an unfolded use configuration in FIG. 18. When in this configuration, a shopper may position bags and the like on shelf panel 326. In addition, the back panel may be provided with bag-retaining cutouts, as described with respect to previous embodiments.

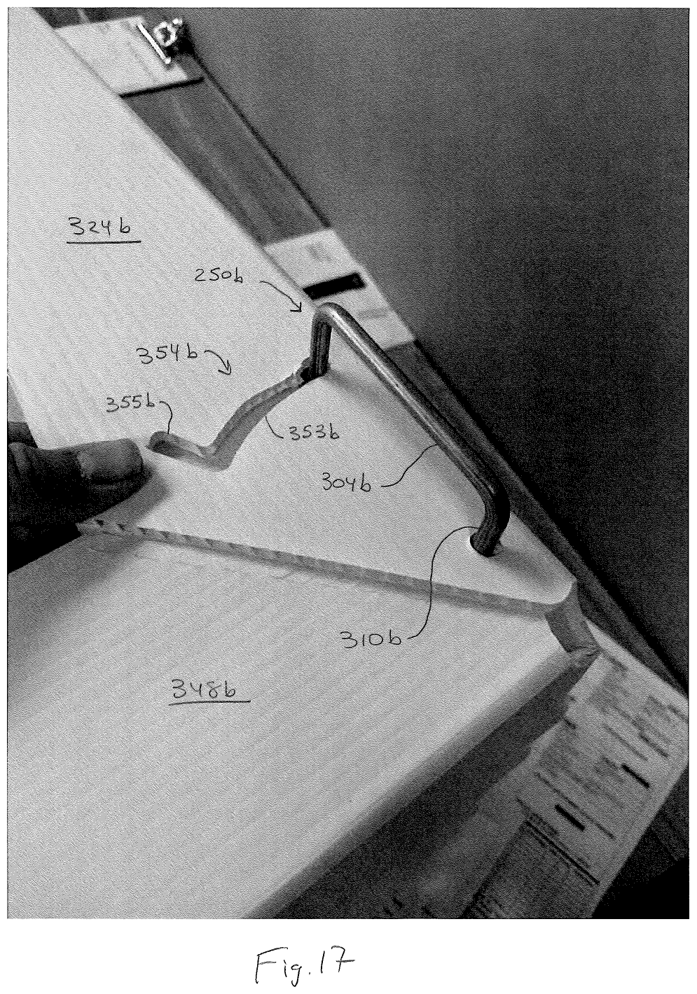

The wheel attachment arrangement for the third embodiment of the trolley will now be described with reference to FIGS. 15-18. The wheel 332b of FIG. 18 has been omitted in FIG. 17 for clarification. As illustrated in FIG. 16, the blank includes auxiliary panels 372a and 372b. Auxiliary panel 372a, which is joined to shelf wing panel 348a by hinge 336a, is provided with a wheel bracket bottom inner opening 352a. Auxiliary panel 372b is similarly provided with a wheel bracket bottom inner opening 352b. Back wing or back wing panel 324a is provided with bracket top slot, indicated in general at 354a, and bracket bottom outer opening 356a, the latter of which is positioned in alignment with wheel bracket bottom inner opening 352a when the trolley body is assembled, as illustrated in FIG. 17. Back wing or back wing panel 324b is similarly provided with bracket top slot, indicated in general at 354b, and bracket bottom outer opening 356b, the latter of which is positioned in alignment with wheel bracket bottom inner opening 352b when the trolley body is assembled, as illustrated in FIGS. 17 and 18.

As illustrated in FIGS. 16 and 17, the bracket top slot 354b includes an arcuate shaped slide portion 353b with an insert portion 355b at one end. The bracket top slot 354a similarly includes an arcuate shaped slide portion 353a with an insert portion 355a at one end.

The auxiliary panel 372a is fastened to the back wing panel 324a, such as by ultrasonic welding, so that the panels are joined in the positions illustrated in FIG. 18. As shown in FIGS. 17 and 18, the same applies for auxiliary panel 372b and back wing panel 324b. Alternative fastening arrangements known in the art, such as adhesives or fasteners (rivets, etc.) may be used in place of ultrasonic welding.

A pair of wheel brackets of the type illustrated in FIG. 15 is used to attach wheels to the trolley body. More specifically, with reference to FIGS. 16-18, the bottom end portion of a wheel bracket (308 in FIG. 15, 308a in FIG. 18) passes through the aligned bracket bottom outer and inner openings (356a and 352a of FIG. 16). The same applies for the bottom end portion on the opposite side of the cart with respect to outer and inner openings 356b and 352b of FIG. 16. With reference to FIG. 17, the top end portion (306 in FIG. 15) of the wheel bracket 250b is then inserted through the insert portion 355b of the bracket top opening 354b and is slid towards the opposite end of the slide portion 353b into the position illustrated in FIG. 17.

It should be noted that there is no opening corresponding to bracket top slot 354a in auxiliary panel 372a. As a result, the top end portion (306 of FIG. 15) of the wheel bracket is trapped between the corresponding auxiliary panel 372a and back wing panel 324a. The auxiliary panel 372a therefore covers the top end portion of the wheel bracket with respect to the interior of the trolley so that the cargo area of the trolley over the shelf panel 326 is shielded from the top end portion of the wheel bracket (as shown in FIG. 18). As a result, the top end portion of the wheel bracket does not to interfere with boxes or other containers positioned on the shelf 326. The same arrangement exists on the other side of the trolley with the auxiliary panel 372b covering and shielding the top end portion of the wheel bracket 250b (FIGS. 17 and 18) from the cargo area of the trolley. In addition, with reference to FIGS. 17 and 18, such an approach for securing the top end portion of the wheel bracket 250b maintains a spaced relation between the abutment portion 304b of the wheel bracket and the back wing panel 324b so that the wheel 332b is free to turn. The same applies for the wheel on the other side of the trolley. Furthermore, the arrangement simplifies assembly of the wheels to the trolley so as to reduce manufacturing burden and cost. Indeed, in alternative embodiments, the trolley could be sold as a kit where the purchaser assembles the wheels to the trolley body.

With the third embodiment of the trolley, the wheel brackets therefore are not used to secure the shelf and corresponding wing panels together (in contrast to the embodiment of FIGS. 6-8 described above).

It should be noted that the wheel attachment arrangement described with respect to FIGS. 15-18 may be used with transport or storage devices other than the illustrated trolley. As an example only, the arrangement may be used to provide a folding four-wheeled wagon or box-like container or the like.

As illustrated in FIG. 18, shelf wing panels 324a and 324b are preferably provided with handle openings 380a and 380b, respectively. The handle openings may be used to carry the cart when in the folded storage or transport configuration. Alternatively, the handle openings 380a and 380b be may be provided with cantilever tabs 382a and 382b to hold the pivoting brace 392 (illustrated at 52 and described in FIGS. 1-5 previously) in the support position illustrated in FIG. 17. The cantilever tabs 382a and 382b are mounted in a resilient fashion at their proximal ends (such as by a living hinge or due to the natural flexibility of the material of the trolley body) so that they may flex to permit release of the pivoting brace 392 so that it may pivot in the direction of arrow 394 as described for previous embodiments.

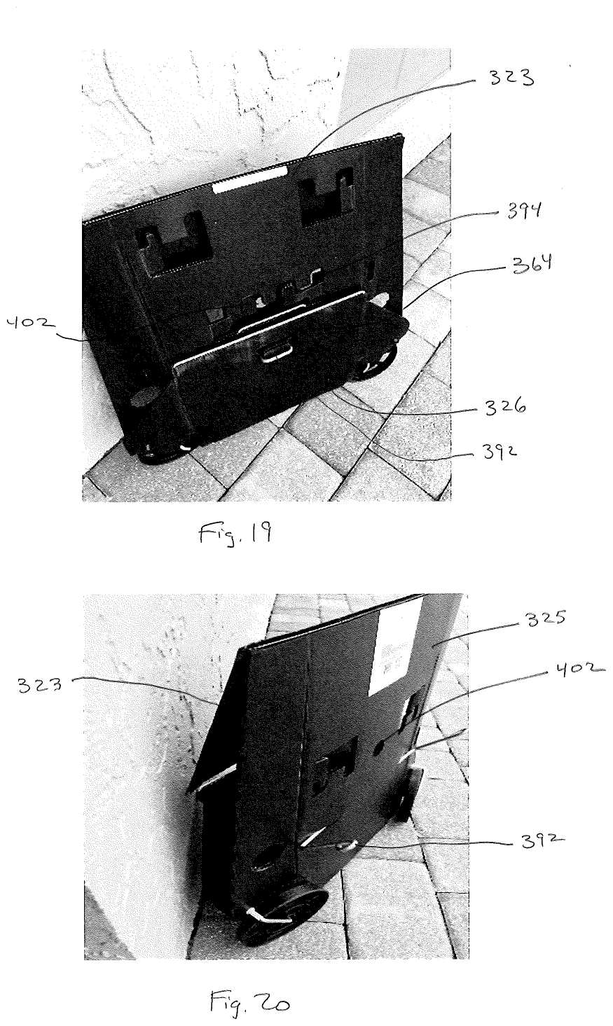

As illustrated in FIG. 16, and noted above, the back panel 322 may be divided by hinge 327 into and back panel upper portion 323 and back panel lower portion 325. This permits a user to fold the back panel into the position illustrated in FIG. 19 to reduce the profile of the trolley for ease of carrying, transport and storage. More specifically, starting with trolley in the partially folded configuration illustrated in FIG. 20, with the pivoting brace 392 in the position illustrated in FIG. 16, the user may fold the top portion 323 of the back panel forward, as illustrated in FIG. 20. The handles 396 of FIG. 16 may be useful for this purpose. The user may then fold shelf panel 326 upwards into the position illustrated in FIG. 19. The fold 327 of FIG. 16 is located so that the folded shelf panel 326 overlays the formerly top edge portion of the back panel upper portion 323 so that the top edge portion is sandwiched between the folded shelf panel 326 and the lower portion 325 of the back panel. The user then positions his or her thumb through the thumb opening 402 (FIGS. 16 and 20) from the back side of the troller (i.e. the side visible in FIG. 20). As illustrated in FIG. 19, the top handle opening 394 (also shown in FIG. 16) is aligned with the thumb opening 402 (also shown in FIGS. 16 and 20) so that the user's thumb also passes through the top handle opening so that the distal edge of the shelf panel 326 (with the folded upper portion 323 of the back panel beneath it) may be held as the pivoting brace 392 is manipulated so as to engage tab 364 (FIGS. 16 and 19) as illustrated in FIG. 17 (and as described above with reference to FIGS. 3 and 4). The trolley is therefore secured in a compact, folded configuration illustrated in FIG. 19 for carrying, transporting and/or storage.

With reference to FIG. 16, a handle flap 398 may be formed when the blank is created. As illustrated in phantom in FIG. 18, the handle flap 398 may be folded against the back side of the back panel 322 and secured in place to provide a reinforced handle opening 394 (FIG. 16) that is more comfortable to grip.

While the preferred embodiments of the invention have been shown and described, it will be apparent to those skilled in the art that changes and modifications may be made therein without departing from the spirit of the invention, the scope of which is set forth in the following claims.

What is claimed is:

1. A collapsible trolley comprising;
a body including:
i. a back panel;
ii. a shelf panel pivotally attached to a bottom edge of the back panel;
iii. a pair of back wing panels pivotally attached one each to opposing side edges of the back panel;
iv. a pair of shelf wing panels pivotally attached one each to opposing side edges of the shelf panel;
v. a pair of auxiliary panels pivotally attached one each to the pair of shelf wing panels and attached one each to bottom edges of the pair of shelf wing panels;
b) said body movable between an unfolded use configuration, where the pair of back wing panels, pair of shelf wing panels and the shelf panel are all generally at an angle of approximately 90° with respect to the back panel so that the pair of back wing panels and the pair of shelf wing panels cooperate to support the shelf panel, and a folded storage configuration where the pair of back wing panels are generally in the same plane as the back panel, the pair of shelf wing panels are generally in the same plane as the shelf panel, the shelf panel overlays a portion of the back panel and the shelf wing panels overlay portions of the back wing panels;
c) a first wheel;
d) a first wheel bracket having a first top end portion, a first bottom end portion and a first abutment portion;
e) a first one of the pair of back wing panels having a first bracket top slot and a first bracket bottom outer opening;
f) a first one of the pair of auxiliary panels having a first bracket bottom inner opening aligned with the first bracket bottom outer opening;
g) the first wheel bracket top end portion secured through the first bracket top slot and the first wheel bracket bottom end portion secured through the first bracket bottom outer and inner openings so that the first wheel is rotatably positioned between the first back wing panel and the first abutment portion of the first wheel bracket and the first wheel bracket top end portion is covered by the first one of the pair of auxiliary panels;
h) a second wheel;
i) a second wheel bracket having a top end portion, a second bottom end portion and a second abutment portion;
j) a second one of the pair of back wing panels having a second bracket top slot and a second bracket bottom outer opening;
k) a second one of the pair of auxiliary panels having a second bracket bottom inner opening aligned with the second bracket bottom outer opening; and
l) the second wheel bracket top end portion secured through the second bracket top slot and the second wheel bracket bottom end portion secured through the second bracket bottom outer and inner openings so that the second wheel is rotatably positioned between the second back wing panel and the second abutment portion of the second wheel bracket and the second wheel bracket top end portion is covered by the second one of the pair of auxiliary panels.

2. The collapsible trolley of claim 1 wherein the pair of auxiliary panels are pivotally attached one each to the pair of shelf wing panels by hinges and attached one each to bottom edges of the pair of shelf wing panels by ultrasonic welding.

3. The collapsible trolley of claim 1 wherein the body is formed from a single piece of corrugated plastic material.

4. The collapsible trolley of claim 1 further comprising a handle opening formed in at least one of the pair of back wing panels.

5. The collapsible trolley of claim 1 further comprising a pivoting brace pivotally attached to the back panel and including a pair of arms that support the pair of back wing panels to restrict them from pivoting outwards when the pivoting brace is pivoted into a support position

6. The collapsible trolley of claim 5 further comprising openings formed one each in the pair of back wing panels, each of said openings including a resilient cantilever tab configured to retain a corresponding one of the pair of arms of the pivoting brace in the support position.

7. The collapsible trolley of claim 1 wherein the first and second wheel brackets are constructed from wire and the first and second top and bottom end portions of the first and second wheel brackets are formed by bends in the wire formed in a common plane.

8. The collapsible trolley of claim 1 wherein the first and second bracket top slots each include an arcuate slide portion and an insert portion, where the insert portion is configured to receive the top end portion of a corresponding wheel bracket with the top end portion of the wheel bracket being trapped between a corresponding back wing panel and auxiliary panel as the wheel bracket is slid into the arcuate side portion of the bracket top slot.

9. The collapsible trolley of claim 1 wherein the back panel includes an upper portion and a lower portion divided by a hinge configured so that the upper portion of the back panel folds over the lower portion and is sandwiched between the lower portion and the shelf panel when the body is in the folded storage configuration.

10. The collapsible trolley of claim 9 further comprising a pivoting brace pivotally attached to the back panel and including a pair of arms such that the pivoting brace pivots between a support position, where the pair of arms support the pair of back wing panels to restrict them from pivoting outwards, and a storage position, where the pivoting brace secures the trolley in the folded storage configuration.

11. A collapsible trolley comprising;
a) a body including:
i. a back panel;
a shelf panel pivotally attached to a bottom edge of the back panel;
iii. a pair of back wing panels pivotally attached one each to opposing side edges of the back panel;
iv. a pair of shelf wing panels pivotally attached one each to opposing side edges of the shelf panel;
v. a pair of auxiliary panels pivotally attached one each to the pair of shelf wing panels and attached one each to bottom edges of the pair of shelf wing panels;
b) said body movable between an unfolded use configuration, where the pair of back wing panels, pair of shelf wing panels and the shelf panel are all generally at an angle of approximately 90° with respect to the back panel so that the pair of back wing panels and the pair of shelf wing panels cooperate to support the shelf panel, and a folded storage configuration where the pair of back wing panels are generally in the same plane as the back panel, the pair of shelf wing panels are generally in the same plane as the shelf panel, the shelf panel overlays a portion of the back panel and the shelf wing panels overlay portions of the back wing panels;
c) a first wheel;
d) a first wheel bracket having a first top end portion, a first bottom end portion and a first abutment portion;
e) a first one of the pair of back wing panels having a first bracket top slot and a first bracket bottom outer opening;
f) a first one of the pair of auxiliary panels having a first bracket bottom inner opening aligned with the first bracket bottom outer opening;
g) the first wheel bracket top end portion secured through the first bracket top slot and the first wheel bracket bottom end portion secured through the first bracket bottom outer and inner openings so that the first wheel is rotatably trapped between the first back wing panel and the first abutment portion of the first wheel bracket and a cargo space over the shelf panel is shielded from the first wheel bracket top end portion by the first one of the pair of auxiliary panels;
h) a second wheel;
i) a second wheel bracket having a top end portion, a second bottom end portion and a second abutment portion;
j) a second one of the pair of back wing panels having a second bracket top slot and a second bracket bottom outer opening;
k) a second one of the pair of auxiliary panels having a second bracket bottom inner opening aligned with the second bracket bottom outer opening; and
l) the second wheel bracket top end portion secured through the second bracket top slot and the second wheel bracket bottom end portion secured through the second bracket bottom outer and inner openings so that the second wheel is rotatably trapped between the second back wing panel and the second abutment portion of the second wheel bracket and the cargo space over the shelf panel is shielded from the second wheel bracket top end portion by the second one of the pair of auxiliary panels.

12. The collapsible trolley of claim 11 wherein the pair of auxiliary panels are pivotally attached one each to the pair of shelf wing panels by hinges and attached one each to bottom edges of the pair of shelf wing panels by ultrasonic welding.

13. The collapsible trolley of claim 11 further comprising a handle opening formed in at least one of the pair of back wing panels.

14. The collapsible trolley of claim 11 further comprising a pivoting brace pivotally attached to the back panel and including a pair of arms that support the pair of back wing panels to restrict them from pivoting outwards when the pivoting brace is pivoted into a support position.

15. The collapsible trolley of claim 14 further comprising openings formed one each in the pair of back wing panels, each of said openings including a resilient cantilever tab configured to retain a corresponding one of the pair of arms of the pivoting brace in the support position.

16. The collapsible trolley of claim 11 wherein the first and second wheel brackets are constructed from wire and the first and second top and bottom end portions of the first and second wheel brackets are formed by bends in the wire formed in a common plane.

17. The collapsible trolley of claim 11 wherein the first and second bracket top slots each include an arcuate slide portion and an insert portion, where the insert portion is configured to receive the top end portion of a corresponding wheel bracket with the top end portion of the wheel bracket being trapped between a corresponding back wing panel and auxiliary panel as the wheel bracket is slid into the arcuate side portion of the bracket top slot.

18. The collapsible trolley of claim 11 wherein the back panel includes an upper portion and a lower portion divided by a hinge configured so that the upper portion of the back panel folds over the lower portion and is sandwiched between the lower portion and the shelf panel when the body is in the folded storage configuration.

19. The collapsible trolley of claim 18 further comprising a pivoting brace pivotally attached to the back panel and including a pair of arms such that the pivoting brace pivots between a support position, where the pair of arms support the pair of back wing panels to restrict them from pivoting outwards, and a storage position, where the pivoting brace secures the trolley in the folded storage configuration.

20. A folding transport device comprising:
a) a body including a pair of wing panels and a pair of auxiliary panels, said body movable between an unfolded use configuration and a folded storage configuration;
b) a first wheel;
c) a first wheel bracket having a first op end portion, a first bottom end portion and a first abutment portion;
d) a first one of the pair of wing panels having a first bracket top slot and a first bracket bottom outer opening;
e) a first one of the pair of auxiliary panels having a first bracket bottom inner opening aligned with the first bracket bottom outer opening;
f) the first wheel bracket top end portion secured through the first bracket top slot and the first wheel bracket bottom end portion secured through the first bracket bottom outer and inner openings so that the first wheel is rotatably positioned between the first wing panel and the first abutment portion of the first wheel bracket and the first wheel bracket top end portion is covered by the first one of the pair of auxiliary panels;
g) a second wheel;
h) a second wheel bracket having a top end portion, a second bottom end portion and a second abutment portion;
i) a second one of the pair of wing panels having a second bracket top slot and a second bracket bottom outer opening;
j) a second one of the pair of auxiliary panels having a second bracket bottom inner opening aligned with the second bracket bottom outer opening; and
k) the second wheel bracket top end portion secured through the second bracket top slot and the second wheel bracket bottom end portion secured through the second bracket bottom outer and inner openings so that the second wheel is rotatably positioned between the second wing panel and the second abut portion of the second wheel bracket and the second wheel bracket top end portion is covered by the second one of the pair of auxiliary panels.
